(19) United States
(12) Patent Application Publication
(10) Pub. No.: US 2011/0126923 A1
(43) Pub. Date: Jun. 2, 2011

(54) Valve Assembly

(75) Inventors: Jan Cornelis De Boer, Aalsmeer (NL); Edwin Hendrikus Cornelis Smit, Hoofddorp (NL)

(73) Assignee: Opw Fluid Transfer Group B.V., Nieuw-Vennep (NL)

(21) Appl. No.: 13/056,272

(22) PCT Filed: Jul. 29, 2009
(86) PCT No.: PCT/EP2009/059822

§ 371 Date: Jan. 27, 2011

(30) Foreign Application Priority Data
Jul. 29, 2008 (GB) 0813836.4
Feb. 16, 2009 (GB) 0902531.3

(51) Int. Cl. F16K 17/18

(52) U.S. Cl. 137/512

(57) ABSTRACT

A valve assembly for a liquid storage tank, the storage tank having a wall, the assembly comprising: a pressure relief conduit; a gas inlet valve device having a gas inlet aperture through which gas may pass into the tank; and a gas outlet valve device having a gas outlet aperture through which gas may pass out from the tank, the inlet valve device and outlet valve device being arranged to control a flow of gas into and out from the storage tank, respectively, whereby a pressure of gas in the tank may be maintained between an upper pressure value being a value in excess of a reference pressure value by a prescribed amount and a lower pressure value being a value below the reference pressure value by a prescribed amount, the gas inlet and outlet apertures being provided in gaseous communication with the pressure relief conduit, the pressure relief of conduit being arranged such that gas flowing into or out from the storage tank by means of an operation of the value assembly is caused to pass through the conduit, the tank further having a liquid inlet, the liquid inlet being switchable between a sealed condition in which liquid may not be fed into the tank through the liquid inlet and an open condition in which liquid may be fed into the tank through the liquid inlet, wherein the inlet valve device comprises a valve member arranged whereby movement of the inlet valve device between closed and open conditions, respectively, the assembly being arranged to be coupled to the tank so as to assume a first orientation in normal use with the tank in the sealed condition, in the first orientation movement of the valve member of the inlet valve device between the open and closed conditions being arranged to involve movement of the valve member in a substantially non-vertical plane.

The present invention relates to valve assemblies. In particular but not exclusively the invention relates to a valve assembly for a liquid storage tank. More particularly but not exclusively the invention relates to a pressure-vacuum vent valve assembly for a liquid storage tank of a road tanker.

### BACKGROUND

Pressure vent valves and vacuum vent valves are important components of certain types of liquid storage tanks including liquid fuel storage tanks. If a pressure of a liquid in a liquid storage tank exceeds a critical value relative to atmospheric pressure a pressure vent valve is arranged to allow venting of vapour from within the storage tank whereby the pressure within the storage tank is reduced. Such a situation might arise as liquid is heated within the storage tank, for example upon exposure of the storage tank to sunlight.

Similarly, if a pressure of liquid in a liquid storage tank falls below a critical value relative to atmospheric pressure, a vacuum vent valve is arranged to allow air or other gas to enter the storage tank. Such a situation might arise as hot liquid cools within a liquid storage tank.

In conventional liquid storage tanks requiring the presence of both a pressure vent valve and a vacuum vent valve, either separate pressure and vacuum vent valves are provided at respective different locations of the storage tank, or a single valve is provided that performs both a pressure outlet function and a vacuum inlet function. Thus, a pressure-vacuum valve functionality is provided whereby the valve is operable to allow gas within the storage tank to escape when a pressure within the storage tank exceeds a critical release pressure, and a vacuum relief functionality in which the valve is operable to allow gas into the storage tank when the pressure within the storage tank falls below a critical intake pressure.

However, difficulty is encountered in designing a valve to provide both gas venting and gas intake operations because the pressure differences between the internal volume of the storage tank and the external volume are very different in magnitude in each case. Consequently, resilient elements operable to bias a closure element of the valve to a closed condition and to allow opening when pressure in the storage tank is too high or too low must have correspondingly different spring constants.

CN2908950 discloses a vacuum pressure valve for installation on a venthole on the top of a solar water heater. The valve allows exhausting of pressure and vacuum generated in the water heater and prevents collapsing or breaking of the water heater. The device comprises a valve body with a negative pressure valve core and a positive pressure valve core set in the valve body.

### STATEMENT OF THE INVENTION

In a first aspect of the invention there is provided a valve assembly coupled to a liquid storage tank, the storage tank having a wall, the assembly comprising:
a pressure relief conduit;
a gas inlet valve device having a gas inlet aperture through which gas may pass into the tank; and
a gas outlet valve device having a gas outlet aperture through which gas may pass out from the tank,
the inlet valve device and outlet valve device being arranged to control a flow of gas into and out from the storage tank, respectively, whereby a pressure of gas in the tank may be maintained between an upper pressure value being a value in excess of a reference pressure value by a prescribed amount and a lower pressure value being a value below the reference pressure value by a prescribed amount, the gas inlet and outlet apertures being provided in gaseous communication with the pressure relief conduit, the pressure relief conduit being arranged such that gas flowing into or out from the storage tank by means of an operation of the valve assembly is caused to pass through the conduit,
the tank further having a liquid inlet, the liquid inlet being switchable between a sealed condition in which liquid may not be fed into the tank through the liquid inlet and an open condition in which liquid may be fed into the tank through the liquid inlet,
wherein the inlet valve device comprises a valve member arranged whereby movement of the valve member between first and second positions results in switching of the inlet valve device between closed and open conditions, respectively, the assembly being arranged to be coupled to the tank so as to assume a first orientation in normal use with the tank in the sealed condition, in the first orientation movement of the valve member of the inlet valve device between the open and closed conditions being arranged to involve movement of the valve member in a substantially non-vertical plane.

Embodiments of the invention have the advantage that improved reliability and performance is obtained relative to a combined pressure-vent valve since separate valves are responsible for gas intake and gas venting operations. At the same time, a reduction of a footprint of the valves at a wall of the storage tank or other structure to which the assembly is attached may be facilitated relative to a footprint in the case that the valves are connected directly to the wall of the storage tank.

By footprint is meant a size of a surface area of the wall that is required in order to install the valves to the wall.

Embodiments of the invention have the further advantage that a risk that the at least one inlet valve device will inadvertently open due to upward and/or downward movement of the valve assembly due for example to movement of a road tanker along a road surface is reduced.

Known vacuum pressure valves are not suitable for coupling to a wall of a liquid storage tank in the configuration whereby in the first orientation movement of the valve member of the inlet valve device between the open and closed conditions is arranged to involve movement of the valve member in a substantially non-vertical plane.

Preferably, in the first orientation movement of the valve member of the inlet valve device between the open and closed conditions is arranged to involve movement of the valve member in a substantially horizontal plane.

Preferably the valve member of the inlet valve device has a face portion, the device further comprising a seat portion provided around the inlet aperture of the inlet valve device, wherein in the first position of the valve member the face portion forms a gas tight seal with the seat portion thereby to block a flow of gas through the inlet aperture and in the second position the face portion does not form a gas tight seal with the seat member thereby to allow a flow of gas through the inlet aperture.

Preferably the outlet valve device comprises a valve member arranged whereby movement of the valve member between first and second positions results in switching of the outlet valve device between the closed and open conditions, respectively, in the first orientation of the assembly movement of the valve member of the outlet valve device between the open and closed conditions being arranged to involve movement of the valve member of the outlet valve device in a substantially non-horizontal plane.

Preferably the outlet valve device has a face portion, the device further comprising a seat portion provided around the outlet aperture of the outlet valve device, the valve member being movable between a first position in which the face portion forms a gas tight seal with the seat portion thereby to block a flow of gas through the outlet aperture and a second position in which the face portion does not form a gas tight seal with the seat portion thereby to allow a flow of gas through the outlet aperture.

The face portions of the valve members of the inlet valve device and the outlet valve device may be oriented in respective different planes.

Said respective different planes may be substantially normal to one another.

Preferably the gas outlet aperture is arranged to be substantially coaxial with the pressure relief conduit.

The reference pressure value may correspond to an ambient atmospheric pressure.

The valve assembly may be coupled to the wall of the storage tank such that the inlet and outlet valve devices are provided on one side of the wall of the storage tank.

The inlet and outlet valve devices are preferably provided on an interior side of the wall of the storage tank.

The valve assembly may be coupled to the wall of the storage tank such that the pressure relief conduit passes substantially through the wall of the storage tank.

Preferably the pressure relief conduit comprises a coupling member arranged to couple the assembly to the wall of the storage tank.

The assembly may comprise a plurality of inlet valve devices and a single outlet valve device.

Alternatively the assembly may comprise a plurality of inlet valve devices and a plurality of outlet valve devices.

Preferably the number of inlet valve devices is greater than the number of outlet valve devices.

The device may further comprise a filter member.

The filter member may also provide a flame arrestor member.

The filter member may be provided in a cavity provided between the pressure relief conduit and the inlet and outlet apertures.

The pressure relief conduit may be arranged to support the inlet and outlet valve devices in a spaced apart relationship with the wall of the storage tank.

Preferably the assembly is arranged to be releasably coupled to the storage tank.

More preferably the assembly is arranged to be releasably coupled to the tank by means of a quick-release coupling.

The assembly may be arranged to be releasably coupled to the tank by means of at least one selected from amongst a bayonet-type coupling and a screw-type coupling.

Preferably the inlet valve device and outlet valve device are each provided with a valve device bias member arranged to bias the respective valve device to the closed condition.

Preferably the respective valve device bias members each comprise a resilient member.

Preferably the assembly is arranged to be coupled to a cover of a manlid assembly of the liquid storage tank, the manlid assembly providing the liquid inlet, the manlid assembly being switchable between the sealed condition in which liquid may not be fed into the tank through the manlid assembly and the open condition in which liquid may be fed into the tank through the manlid assembly.

Preferably the assembly is releasably coupled to the cover of the manlid assembly.

Preferably the assembly is coupled to the cover such that with the manlid assembly in the sealed condition the assembly is provided on an inside of the liquid storage tank.

The inlet valve bias member is preferably arranged to be provided on a side of the valve member upstream of the gas inlet aperture when the assembly is provided on an inside of the liquid storage tank.

Preferably the assembly is arranged whereby the outlet valve bias member is provided on a side of the outlet valve member downstream of the gas outlet aperture.

In a second aspect of the invention there is provided a road tanker comprising an assembly according to the first aspect of the invention.

In a third aspect of the invention there is provided a liquid fuel road tanker comprising an assembly according to the first aspect of the invention.

In a further aspect of the invention there is provided a valve assembly for a fluid storage tank comprising: a pressure relief conduit; a fluid inlet valve device having a fluid inlet aperture through which fluid may pass into the tank; and a fluid outlet valve device having a fluid outlet aperture through which fluid may pass out from the tank, the inlet valve device and outlet valve device being arranged to control a flow of fluid into and out from the storage tank, respectively, whereby a pressure of fluid in the tank may be maintained between an upper pressure value being a value in excess of a reference value by a prescribed amount and a lower pressure value being a value below the reference value by a prescribed amount, the fluid inlet and outlet apertures being provided in fluid communication with the pressure relief conduit, the pressure relief conduit being arranged such that fluid flowing into or out from the storage tank by means of an operation of the valve assembly is caused to pass through the conduit.

Embodiments of the invention have the advantage that improved reliability and performance is obtained relative to a combined pressure-vent valve since separate valves are responsible for fluid intake and fluid venting operations. At the same time, a reduction of a footprint of the valves at a wall of the storage tank or other structure to which the assembly is attached may be facilitated relative to a footprint in the case that the valves are connected directly to the wall of the storage tank.

By footprint is meant a size of a surface area of the wall that is required in order to install the valves to the wall.

Preferably the at least one inlet valve device is arranged to assume an open condition in which fluid may pass through the inlet aperture when the pressure within the tank is below the lower pressure value and to assume a closed condition in which fluid may not pass through the inlet aperture when the pressure within the structure is not below the lower pressure value, the at least one outlet valve device being arranged to assume an open condition in which fluid may pass out from the tank when a pressure within the tank is above the upper pressure value and to assume a closed condition in which fluid may not pass through the outlet aperture when the pressure within the tank is not above the upper pressure value.

Preferably the reference pressure corresponds to an ambient atmospheric pressure.

The valve assembly may be arranged to be coupled to a wall of the storage tank such that the inlet and outlet valve devices are provided on one side of the wall of the storage tank.

Preferably the inlet and outlet valve devices are provided on an interior side of the wall of the storage tank.

Preferably the valve assembly is arranged to be coupled to the wall of the storage tank such that the fluid conduit passes substantially through the wall of the storage tank.

Preferably the fluid conduit comprises a coupling member arranged to couple the assembly to the wall of the storage tank.

The coupling member may comprise a screw member such as a threaded portion or any other suitable coupling member.

movement of the valve member between first and second positions results in switching of the inlet valve device between the closed and open conditions, respectively.

The assembly is preferably arranged to be oriented in use whereby movement of the valve assembly in a substantially vertical direction does not increase a risk that the inlet valve device will assume the open condition due to inertia of the valve member when the pressure within the structure is not below the lower pressure value.

This has the advantage of reducing a risk that the at least one inlet valve device will inadvertently open due to upward and/or downward movement of the valve assembly due for example to movement of a road tanker along a road surface.

In some embodiments this has the further advantage that a valve member having an increased area relative to known inlet valve devices may be provided. This is because in some embodiments the cross-sectional area of an aperture closed by the valve member may be made larger than the footprint of the valve assembly with respect to a surface to which the valve assembly is mounted.

Alternatively or in addition the assembly may be arranged to be oriented in use whereby movement of the valve assembly in a substantially vertical direction does not increase a risk that the outlet valve device will assume the open condition due to inertia of a valve member of the outlet valve device when the pressure within the structure is not above the upper pressure value.

The assembly may be arranged to be coupled to the tank so as to assume a first orientation in normal use, in the first orientation movement of the valve member of the inlet valve device between the open and closed conditions being arranged to involve movement of the valve member in a substantially horizontal plane.

Alternatively or in addition the assembly may be arranged to be coupled to the tank so as to assume a first orientation in normal use, in the first orientation movement of the valve member of the outlet valve device between the open and closed conditions being arranged to involve movement of the valve member of the outlet valve device in a substantially horizontal plane.

In other words, in some embodiments the inlet valve device and outlet valve device are both oriented so that movement of the valve members of the devices between the open and closed conditions involves movement of the valve members in a substantially horizontal plane.

Preferably the valve member of the inlet valve device has a face portion, the device further comprising a seat portion provided around the inlet aperture of the inlet valve device, wherein in the first position of the valve member the face portion forms a fluid tight seal with the seat portion thereby to block a flow of fluid through the inlet aperture and in the second position the face portion does not form a fluid tight seal with the seat member thereby to allow a flow of fluid through the inlet aperture.

Preferably the outlet valve device comprises a valve member having a face portion, the device further comprising a seat portion provided around the outlet aperture of the outlet valve device, the valve member being movable between a first position in which the face portion forms a fluid tight seal with the seat portion thereby to block a flow of fluid through the outlet aperture and a second position in which the face portion does not form a fluid tight seal with the seat portion thereby to allow a flow of fluid through the outlet aperture.

The face portions of the valve members of the inlet valve device and the outlet valve device may be oriented in respective different planes.

Said respective different planes may be substantially normal to one another.

An axis of the fluid outlet aperture may be arranged to be substantially coaxial with a longitudinal axis of the fluid conduit.

Preferably an axis of the fluid inlet aperture is provided substantially normal to the longitudinal axis of the fluid conduit.

Preferably the assembly comprises a plurality of inlet valve devices and a single outlet valve device.

The presence of more than one inlet valve device has the advantage that an increased flow rate of gas into the storage tank may be obtained relative to a device having only one inlet valve device. This can be particularly useful during operations such as fuel delivery where it may be required to relieve a vacuum created by loss of fuel from the tank in a rapid manner.

Preferably the assembly comprises a plurality of inlet valve devices and a plurality of outlet valve devices.

The number of inlet valve devices may be greater than the number of outlet valve devices.

The assembly may further comprise a filter member.

The filter member may also provide a flame trap member.

Preferably the filter member is provided in a cavity provided between the fluid conduit and the inlet and outlet apertures.

Preferably the pressure relief conduit is arranged to support the inlet and outlet valve devices in a spaced apart relationship with the wall of the storage tank.

### BRIEF DESCRIPTION OF THE DRAWINGS

For a better understanding of the present invention, and to show how it may be carried into effect, reference will now be made by way of example to the accompanying drawings, in which:

FIG. 1 is a cut-away schematic diagram of a valve assembly according to an embodiment of the invention;

FIG. 2 is an enlarged cut-away schematic diagram of a portion of a valve assembly according to the embodiment of FIG. 1;

FIG. 3 is an exploded view of a valve assembly according to the embodiment of FIG. 1; and

FIG. 4 shows a valve assembly according to an embodiment of the invention coupled to a cover of a manlid.

### DETAILED DESCRIPTION

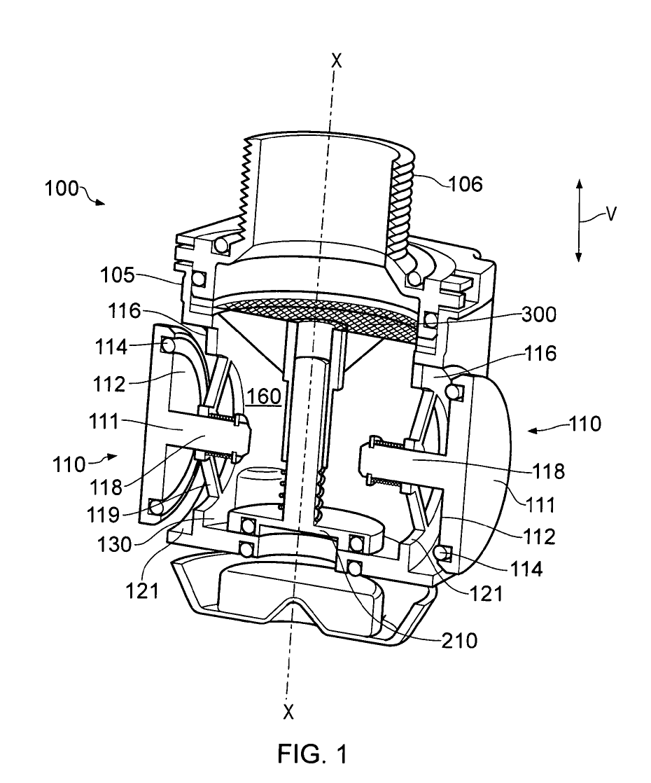

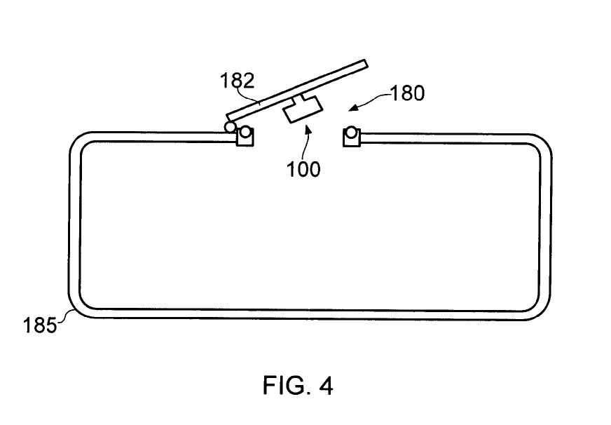

FIG. 1 shows a valve assembly 100 according to an embodiment of the invention. The valve assembly 100 has a body portion 105 and a connector portion 106 arranged to couple the body portion 105 to a liquid storage tank. In some embodiments the valve assembly 100 is arranged to be coupled to a cover 182 of a manlid assembly 180 fitted to a storage tank 185 as shown in FIG. 4.

The valve assembly 100 has a pair of inlet valve devices 110 in the form of poppet valve devices provided on generally opposite sides of the body portion 105. The inlet valve devices 110 each have a valve member 111 having a face portion 112 having a seal element 114 provided around a periphery thereof. The seal element 114 is arranged to abut a seat portion 116 of the inlet valve device 110 thereby to form a fluid tight seal between the valve member 111 and the seat portion 116 thereby closing a fluid inlet aperture 121 provided in the body portion 105.

A stem 118 of the inlet valve device is provided with a coil spring 119 therearound, the coil spring 119 being arranged to bias the stem 118 to a position in which the seal element 114 is in abutment with the seat portion 116. With the seal element 114 in abutment with the seat portion 116 fluid is unable to flow through the inlet aperture 121.

When a pressure in the storage tank falls to a value such that a pressure drop across the valve member 111 exceeds a critical intake pressure value relative to ambient pressure the valve member 111 is arranged to be displaced such that a fluid flowpath is provided through the aperture 121.

The presence of two inlet valve devices 110 allows an increase in a flow rate of fluid into the storage tank when the fluid flowpath is provided through the aperture 121.

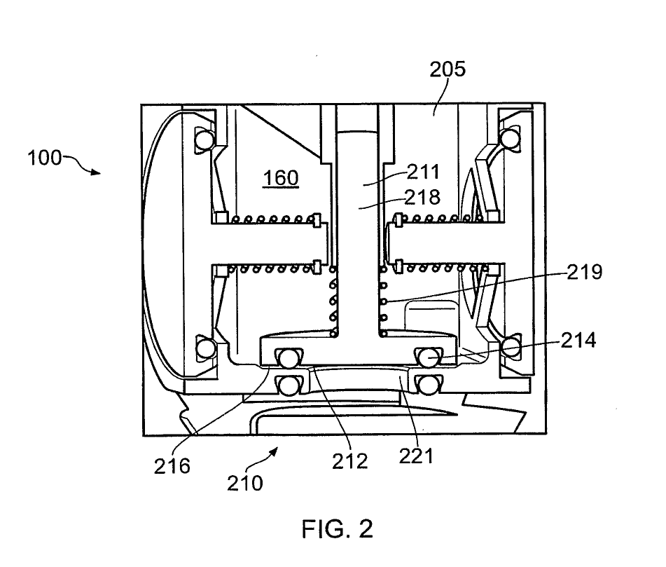

The valve assembly 100 is also provided with a pressure outlet valve device 210 (FIG. 2) having a valve member 211 having a face portion 212 having a seal element 214 provided around a periphery thereof. The seal element 214 is arranged to abut a seat portion 216 of the inlet valve device 210 thereby to form a fluid tight seal between the valve member 211 and the seat potion 216 thereby closing a fluid outlet aperture 221 provided in the body portion 105.

As in the case of the inlet valve device 110, the outlet valve device 210 is provided with a coil spring 219 therearound, the coil spring 219 being arranged to bias a stem 218 of the valve member 211 to a position in which the seal element 214 is in abutment with the seat portion 216. With the seal element 214 in abutment with the seat portion 216 fluid is unable to flow through the outlet aperture 221.

When a pressure in the storage tank rises above a critical value such that a pressure within the storage tank exceeds a critical vent pressure value relative to ambient pressure, the valve member 211 is arranged to be displaced such that a fluid flow path is provided through the aperture 221 whereby fluid may be vented from the storage tank.

The connector portion 106 of the housing portion 105 (FIG. 1) provides a fluid conduit through which fluid may be drawn into or vented from a storage tank or other structure to which the valve assembly 100 is connected.

The connector portion 106 has a connector portion longitudinal axis (line X-X), the inlet valve devices 110 being arranged about the longitudinal axis such that axial movement of the valve members 111 occurs in a plane normal to the line X-X. In use, the valve assembly is mounted to the fluid storage tank or other structure such that the connector portion longitudinal axis is provided in a substantially vertically upright orientation. Consequently, abrupt vertical movement of the valve assembly 100 (as indicated by arrow V) is less likely to result in inadvertent movement of a valve member 111 to open or close the aperture 121. This is in contrast to prior art devices in which movement of the valve member of an inlet valve is typically arranged to occur in a generally vertical direction.

The present design has the further advantage that the inlet aperture 121 may be made relatively large without increasing a size of the footprint of the valve assembly 100 at the location of the storage tank or other structure at which the valve assembly 100 is coupled to the storage tank or other structure. This is at least in part because the inlet and outlet valve devices are coupled to a wall of the storage tank by means of the conduit provided by the connector portion 106. A footprint of the connector portion at the wall of the storage tank may be made much smaller than a size of a corresponding combined footprint of the inlet and outlet devices 110, 210 if the devices were each coupled individually to the wall of the storage tank.

By ‘footprint’ is meant a minimum size of a surface area of the storage tank or other structure required for installation of the valve assembly thereto.

The presence of two vacuum inlet devices has the advantage that an increased flow rate of fluid through the inlet aperture 121 may be achieved allowing relatively rapid relief of a vacuum condition established in the storage tank or other structure to which the valve assembly 100 is coupled.

Furthermore, embodiments of the invention have the advantage that inadvertent opening of an inlet valve device due to abrupt vertical movement of the valve assembly 100 is reduced. This is at least in part because the valve member of the inlet valve device is arranged such that in use movement of the valve member between open and closed conditions takes place in a generally horizontal plane. Consequently, abrupt movement of the valve assembly 100 such as may occur during haulage of a liquid storage tank to which a valve assembly 100 is coupled results in forces that act in a direction substantially normal to that of movement of the valve member. Thus, substantially no effect on valve operation is caused by vertical movement of the valve assembly.

In the embodiment of FIG. 1 it can be seen that a cavity 160 is provided in a region between the inlet valve devices 110 and between the inlet valve devices 110 and the connector portion 106. A flame arrestor/filter member 300 is provided in this region. Flame arrestor/filter members typically introduce a substantial flow restriction. However, in some embodiments such as that of FIG. 1 the arrangement of the valve devices 110, 210 and connector portion 106 is such that a relatively large flame arrestor/filter member 300 may be provided thereby reducing an extent to which the flame arrestor/filter member restricts a flow of fluid through the assembly 100.

In some embodiments such as those shown in the illustrations the coil springs 119, 219 are arranged to be provided on an opposite side of the corresponding fluid inlet and outlet apertures 121, 221 to the liquid stored in the tank. Thus, coil spring 119 is provided upstream of a flow of fluid into the tank through the inlet aperture 121 and coil spring 219 is provided downstream of a flow of fluid out from the tank through the outlet aperture 221.

This feature has the advantage that coil springs 219 of the pressure outlet valve device 210 are not exposed to liquid or vapours of the tank except when a flow of fluid (such as liquid vapours or liquid itself) occurs through the outlet aperture 221. Similarly, coil springs 119 of the pressure outlet valve device 110 are not exposed to liquid or vapours of the tank except, in some embodiments, when a flow of fluid (such as liquid vapours or liquid itself) occurs through the outlet aperture 221.

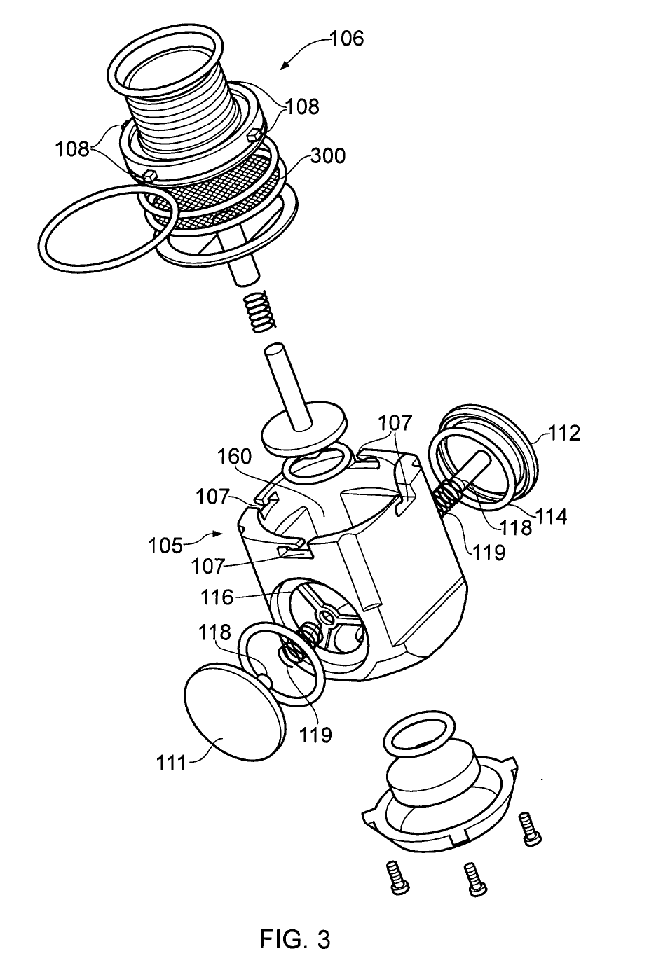

In the embodiment of FIG. 3 the body portion 105 is arranged to be releasably connectable to the connector portion 106. This feature allows removal of the body portion 105 for maintenance such as cleaning or replacement. A variety of couplings are useful for connecting the body portion 105 to the connector portion 106, such as a bayonet-type coupling, a screw-type coupling or any other suitable coupling. Quick-release type couplings such as the bayonet-type coupling are particularly useful.

In the embodiment shown in the figures the body portion is arranged to couple to the connector portion 106 by means of a bayonet-type coupling. Accordingly the body portion is provided with pin-receiving tracks 107 each arranged to receive a corresponding pin 108 protruding from the connector portion 106.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A valve assembly coupled to a liquid storage tank, the storage tank having a wall, the assembly comprising:
a pressure relief conduit;
a gas inlet valve device having a gas inlet aperture through which gas may pass into the tank; and
a gas outlet valve device having a gas outlet aperture through which gas may pass out from the tank,
the inlet valve device and outlet valve device being arranged to control a flow of gas into and out from the storage tank, respectively, whereby a pressure of gas in the tank may be maintained between an upper pressure value being a value in excess of a reference pressure value by a prescribed amount and a lower pressure value being a value below the reference pressure value by a prescribed amount, the gas inlet and outlet apertures being provided in gaseous communication with the pressure relief conduit, the pressure relief conduit being arranged such that gas flowing into or out from the storage tank by means of an operation of the valve assembly is caused to pass through the conduit,
the tank further having a liquid inlet, the liquid inlet being switchable between a sealed condition in which liquid may not be fed into the tank through the liquid inlet and an open condition in which liquid may be fed into the tank through the liquid inlet,
wherein the inlet valve device comprises a valve member arranged whereby movement of the valve member between first and second positions results in switching of the inlet valve device between closed and open conditions, respectively, the assembly being arranged to be coupled to the tank so as to assume a first orientation in normal use with the tank in the sealed condition, in the first orientation movement of the valve member of the inlet valve device between the open and closed conditions being arranged to involve movement of the valve member in a substantially non-vertical plane.

2. An assembly as claimed in claim 1 wherein in the first orientation movement of the valve member of the inlet valve device between the open and closed conditions is arranged to involve movement of the valve member in a substantially horizontal plane.

3. An assembly as claimed in claim 1 wherein the valve member of the inlet valve device has a face portion, the device further comprising a seat portion provided around the inlet aperture of the inlet valve device, wherein in the first position of the valve member the face portion forms a gas tight seal with the seat portion thereby to block a flow of gas through the inlet aperture and in the second position the face portion does not form a gas tight seal with the seat member thereby to allow a flow of gas through the inlet aperture.

4. An assembly as claimed in claim 3 wherein the outlet valve device comprises a valve member arranged whereby movement of the valve member between first and second positions results in switching of the outlet valve device between the closed and open conditions, respectively, in the first orientation of the assembly movement of the valve member of the outlet valve device between the open and closed conditions being arranged to involve movement of the valve member of the outlet valve device in a substantially non-horizontal plane.

5. An assembly as claimed in claim 4 wherein the outlet valve device has a face portion, the device further comprising a seat portion provided around the outlet aperture of the outlet valve device, the valve member being movable between a first position in which the face portion forms a gas tight seal with the seat portion thereby to block a flow of gas through the outlet aperture and a second position in which the face portion does not form a gas tight seal with the seat portion thereby to allow a flow of gas through the outlet aperture.

6. An assembly as claimed in 5 wherein the face portions of the valve members of the inlet valve device and the outlet valve device are oriented in respective different planes.

7. An assembly as claimed in claim 6 wherein said respective different planes are substantially normal to one another.

8. An assembly as claimed in claim 1 wherein the gas outlet aperture is arranged to be substantially coaxial with the pressure relief conduit.

9. An assembly as claimed in claim 1 wherein the reference pressure value corresponds to an ambient atmospheric pressure.

10. An assembly as claimed in claim 1 wherein the valve assembly is coupled to the wall of the storage tank such that the inlet and outlet valve devices are provided on one side of the wall of the storage tank.

11. An assembly as claimed in claim 1 arranged wherein the inlet and outlet valve devices are provided on an interior side of the wall of the storage tank.

12. An assembly as claimed in claim 1 wherein the valve assembly is coupled to the wall of the storage tank such that the pressure relief conduit passes substantially through the wall of the storage tank.

13. An assembly as claimed in claim 1 wherein the pressure relief conduit comprises a coupling member arranged to couple the assembly to the wall of the storage tank.

14. (canceled)

15. An assembly as claimed in claim 1 further comprising a plurality of inlet valve devices and a single outlet valve device.

16. An assembly as claimed in claim 15 wherein the number of inlet valve devices is greater than the number of outlet valve devices.

17. An assembly as claimed in claim 1 further comprising a filter member.

18. An assembly as claimed in claim 17 wherein the filter member also provides a flame arrestor member.

19. An assembly as claimed in claim 17 wherein the filter member is provided in a cavity provided between the pressure relief conduit and the inlet and outlet apertures.

20. An assembly as claimed in claim 1 wherein the pressure relief conduit is arranged to support the inlet and outlet valve devices in a spaced apart relationship with the wall of the storage tank.

21. An assembly as claimed in claim 1 arranged to be releasably coupled to the storage tank.

22. An assembly as claimed in claim 1 arranged to be releasably coupled to the tank by means of a quick-release coupling.

23. An assembly as claimed in claim 1 arranged to be releasably coupled to the tank by means of at least one selected from amongst a bayonet-type coupling and a screw-type coupling.

24. An assembly as claimed in claim 1 wherein the inlet valve device and outlet valve device are each provided with a valve device bias member arranged to bias the respective valve device to the closed condition.

25. An assembly as claimed in claim 24 wherein the respective valve device bias members each comprise a resilient member.

26. An assembly as claimed in claim 1 coupled to a cover of a manlid assembly of the liquid storage tank, the manlid assembly providing the liquid inlet, the manlid assembly being switchable between the sealed condition in which liquid may not be fed into the tank through the manlid assembly and the open condition in which liquid may be fed into the tank through the manlid assembly.

27. An assembly as claimed in claim 26 wherein the assembly is releasably coupled to the cover of the manlid assembly.

28. An assembly as claimed in claim 27 wherein the assembly is coupled to the cover such that with the manlid assembly in the sealed condition the assembly is provided on an inside of the liquid storage tank.

29. An assembly as claimed in claim 24 wherein the inlet valve bias member is arranged to be provided on a side of the valve member upstream of the gas inlet aperture when the assembly is provided on an inside of the liquid storage tank.

30. An assembly as claimed in claim 24 arranged whereby the outlet valve bias member is provided on a side of the outlet valve member downstream of the gas outlet aperture.

31. A road tanker comprising an assembly as claimed in claim 1.

32. A liquid fuel road tanker comprising an assembly as claimed in claim 1

33.-34. (canceled)
